(19) United States
(12) Patent Application Publication
(10) Pub. No.: US 2010/0268450 A1
(43) Pub. Date: Oct. 21, 2010

(54) PEDESTRIAN NAVIGATION SYSTEMAND METHOD INTEGRATED WITH PUBLIC TRANSPORTATION

(76) Inventor: Eugene Stephen Evanitsky, Pittsford, NY (US)

Correspondence Address: Xerox Corporation (CDFS), 445 Broad Hollow Rd.-Suite 420, Melville, NY, 11747, US

(21) Appl. No.: 12/424,103

(22) Filed: Apr. 15, 2009

(51) Int. Cl. G01C 21/36

(52) U.S. Cl. 701/201

(57) ABSTRACT

A method according to the present disclosure includes receiving information, including a user-desired destination as an end location, from a user-operated computing device and electronically determining a current location of a user as a beginning location based on positional information received at the user-operated computing device. The method also includes electronically generating potential routes from the beginning location to the end location based on the information and electronically selecting one of the potential routes as a selected route. The method also includes outputting, to the user-operated computing device, the electronically selected route. The selected route includes one or more of a mass transit portion, a motor vehicle route portion, and a pedestrian walking route portion. The method also includes outputting, to the user-operated computing device, navigation instructions based on a then-current location of the user between the beginning location and the end location.

### BACKGROUND

1. Technical Field

The present disclosure relates to navigational systems and methods, and, in particular, to a computerized device adapted to generate directions through different combinations of public transportation and pedestrian travel routes.

2. Description of Related Art

The majority of conventional computerized navigation systems arc designed for directing vehicles from a source to a destination based on a start address and an end address. Such conventional systems can also recalculate a route based on dynamic information such as a missed turn. Other systems arc available for hikers which provide a general direction of travel needed to reach an input destination. For example, many different types of global positioning system (GPS) based navigation systems arc currently available from manufactures such as Garmin, Ltd. and Magellan Navigation, Inc., and details of such systems are not discussed in detail herein to allow the reader to focus on the salient features of the present disclosure.

However, such conventional systems are of little use to a pedestrian in a large city who is not driving a car or navigating a forest, but instead is traveling along sidewalks and riding on public transportation systems, such as busses, subways, and taxi cabs. Further, travelers may include travel plans that require air travel. Prior to the present disclosure, in order to navigate the mass transit system(s) users had to be able to read maps of the transit routes and correlate them with street addresses. One problem encountered when navigating within urban environments is that large cities often have multiple mass transit systems (e.g. subway, busses, and ferries) and do not have a comprehensive system to combine these routes to facilitate travel within the metropolitan area or between metropolitan areas (e.g., air travel).

### SUMMARY

According to an embodiment of the present disclosure, a method according to the present disclosure includes receiving information, including a user-desired destination as an end location, from a user-operated computing device and electronically determining a current location of a user as a beginning location based on positional information received at the user-operated computing device. The method also includes electronically generating potential routes from the beginning location to the end location based on the information and electronically selecting one of the potential routes as a selected route. The method also includes outputting, to the user-operated computing device, the electronically selected route. The selected route includes one or more of a mass transit portion, a motor vehicle route portion, and a pedestrian walking route portion. The method also includes outputting, to the user-operated computing device, navigation instructions based on a then-current location of the user between the beginning location and the end location.

According to another embodiment of the present disclosure, a system includes a navigation system including a network server adapted to receive, as user input, a desired destination as an end location from a user-operated computing device. The user-operated computing device is adapted to receive wireless positional information to calculate a current location of the user-operated device as a beginning location. The system also includes a processor operably connected to an instruction module and a memory adapted to store transit data received, by the processor, from a transit data source. The instruction module is configured to calculate potential routes from the beginning location to the end location based on the stored transit data and to select one of the potential routes as a selected route. The user-operated computing device is adapted to receive, as output from the network server, at least one of the selected route and real-time navigation instructions based on a then-current location of the user-operated computing device. The system also includes a livery service utility operating on the network server. The livery service utility is adapted to receive, as user input, a request for a livery service vehicle to the then-current location of the user-operated computing device. The user-operated computing device is adapted to receive, as output from a corresponding livery service, a confirmation that the livery service will dispatch a livery service vehicle to the then-current location of the user-operated computing device.

According to another embodiment of the present disclosure, a method includes receiving information, including at least one of a user-desired destination as an end location and an air travel itinerary, from a user-operated computing device. The method also includes electronically determining a current location of a user as a beginning location based on positional information received from the user-operated computing device and electronically generating potential routes from the beginning location to the end location. The method also includes electronically selecting one of the potential routes as a selected route and outputting, to the user-operated computing device, the electronically selected route. The electronically selected route includes at least one of a mass transit portion, a motor vehicle route portion, and a pedestrian walking route portion. The method also includes outputting, to the user-operated computing device, navigation instructions based on at least one of the air travel itinerary and a then-current location of the user between the beginning location and the end location and dynamically regenerating the selected route based on the then-current location of the user.

### BRIEF DESCRIPTION OF THE DRAWINGS

These and other advantages will become more apparent from the following detailed description of the various embodiments of the present disclosure with reference to the drawings wherein:

FIG. 1 is a schematic representation of a system according to embodiments of the present disclosure; and

FIG. 2 is a How diagram illustrating use of the system of FIG. 1.

### DETAILED DESCRIPTION

Embodiments of the presently disclosed system will now be described in detail with reference to the drawings in which like reference numerals designate identical or corresponding elements in each of the several views.

Generally, the present disclosure relates to a pedestrian navigation system that integrates navigational technology (e.g., GPS, cell phone infrastructure, etc.) with public transportation data to generate dynamic directions between two or more locations to a user via a display/input device such as, for example, a cell phone. The system also generates real-time navigational instructions to the user via the display/input device while the user is traversing between the two or more locations.

More specifically, the pedestrian navigation system incorporates a display/input device adapted to be tracked by a navigational satellite. The display/input device is suited for bidirectional communication with a pedestrian navigation system that includes logic necessary to generate detailed directions From a starting location to a user-entered destination. With this purpose in mind, the pedestrian navigation system makes available to the display/input device, digitized maps and/or mapping programs, addresses of points of interest, and detailed information relating to air travel (e.g., airline schedules, fares, ticketing, etc.).

Further, the pedestrian navigation system is in communication with a transit data source corresponding to a given city and/or metropolitan area. The transit data source includes real-lime information regarding the tracked location of transit vehicles to generate estimated arrival times, transit routes, transit schedules, and boarding locations of public transportation including, but not limited to, busses, trains, subways, airplanes, ferries, trolleys, cable cars, tramcars, street cars, monorails, etc. Utilizing this information provided by the transit data source, the directions produced by the pedestrian navigation system optimize the use of public transportation. More specifically, the pedestrian navigation system directs the user to the closest mass transit entry point (e.g., bus stop, subway station, airport terminal/gate, etc.) and, further, navigates the user through the transit system, in real-time, to the location closest to the entered destination. The system tracks the user during public transportation travel to generate these real-time navigational instructions to the user through the display/input device. In this manner, the system may alert the user in real-time when and where to get off or exit a public transit vehicle. In this scenario, real-time navigation instructions relating to air travel may be different from other forms of public transportation in that real-time instructions will correspond to departure destinations, layover destinations, and arrival destinations rather than in-flight instructions to exit an airplane.

Walking distances may be provided to allow the user to determine if alternative modes of transportation, such as a livery service (e.g. taxi, limousine), are required or desired. If required or desired, the display/input device may be used to generate a call or request to a taxi and/or limousine service utility. Then-current location information may be made available to a particular livery service by the display/input device so that the livery service may dispatch a vehicle to the user's location upon receiving the call or request. A confirmation may be generated from the livery service to the display/input device to inform the user that a vehicle has been dispatched to their destination and/or to provide an estimated arrival time of the vehicle. Further, the display/input device may be utilized to cancel the request to the livery service.

In embodiments, the pedestrian navigation system includes an air travel assist utility accessible by the display/input device. The air travel assist utility is adapted to be accessed by the display/input device (e.g., the user's cell phone) to accept the users flight itinerary and profile information. In a practical scenario, connecting to the air travel assist utility may be accomplished through a speed dial on the user's cell phone. Information made available to the display/input device may include, without limitation, traffic conditions in route to the airport, flight time confirmations, airport maps, flight alerts, flight schedules, check-in information, automatic rerouting options in the event of a canceled flight, walking directions to the correct gate, airport terminal, luggage pick-up, customs, immigration, ground transportation, directions to gates for connecting flights, directions to so-called red carpet lounges, wake-up calls during delays or waiting times, etc. Further, the user may make a call or request to a livery service, as discussed above, for airport limousine service from the airport to a desired destination. In embodiments, the air travel assist utility may be hosted as a web-based service (e.g., by an internet service provider) to provide travel services to subscribing customers with a suitable network enabled computing device, such as a cell phone. For example, the hosted travel service may process and manage customer data such as traveler profiles, itineraries, plane schedules, flight history, location services, and the like, to provide subscribing customers a complete navigation and tracking travel service.

In use of the air travel assist utility, the user sends or registers their flight itinerary (e.g., a hard copy or electronic image) to the pedestrian navigation system. The day of the user's flight, the system may provide such information to the user as a check list of items (e.g., medicines, travel documents such as visas or passports, tickets, electronic ticketing information, phone numbers, clothing items, etc.) and travel tips specific to a particular city or country. Further, the display/input device may be used to take a picture of the user's luggage and/or luggage ID tags and further, to upload the identification data or images to the pedestrian navigation system for future reference in the event of lost luggage.

En-route to the airport, the user/input device may be used to verify that a flight is on time, electronically check in, acquire travel conditions between a starting point and the airport, and automatically provide frequent flyer miles on the user's tickets.

Upon arrival at the airport, the system may provide to the user via the display/input device, walking directions to locations such as, for example, curbside check-in, ticketing, security check-in, gate location, and red-carpet lounge. Further, the system may provide access to airport rules corresponding to luggage, carry-on restrictions, plastic bottles, and the like. The display/input device may be used to arrange for wheel chairs, passenger assisted transportation, and to generate a wake-up call to the user in the event the user falls asleep while waiting for a flight or a connecting flight. Also, the system may reproduce passport information (e.g., via a system or service website) which may help the user to obtain replacement documentation.

In-flight or during connecting (lights, the system may provide the user with connecting flight information such as, for example, scheduled boarding times, estimated take-off times, gale numbers and locations, and the like. In the event that a flight or connecting flight is cancelled, the user may utilize the display/input device to request a list of alternative flights and available seating on such flights. Further, the display/input device may be utilized to select an alternative flight and have all related transaction work completed without having to stand in line at the airport. Once a user is inside the airport of a connecting flight, the system may provide walking directions from a starting point to the gate of the connecting flight.

Post-flight, the system may provide walking directions to the baggage claim, immigration/customs, ground transportation, and the like. In the event the user's luggage has been lost or misplaced, the display/input device may be utilized to generate an email to the luggage claim area including the user's travel particulars such as, for example, where to deliver the luggage once it is found and pictures or identifying marks of the luggage. In this manner, no forms need to be filled-out. Further, the user may make a call or request to a livery service, as discussed above, for airport limousine service from the airport to a desired destination. If renting a vehicle, the system provides the user with turn-by-turn driving directions to a user selected destination.

The air travel assist utility may include a safety feature configured to track the travel progress of a child and/or senior citizen. More specifically, if a child or senior citizen is traveling, the system may track the progress of the passenger (e.g., through a display/input device) lo generate messages to the parent or guardian regarding the tracked progress. In this manner, those concerned need not connect to an airline website for flight information.

In embodiments, the disclosed pedestrian navigation system may be hosted as a web-based service (e.g., by an internet service provider) to provide navigation and/or tracking services to subscribing customers with a suitable network enabled computing device, such as a cell phone.

In use of the system of the present disclosure, a desired destination is received from user input as the end location. The end location may be input in any manner, such as a street address, street intersection, latitude/longitude location, point of interest name, or any other useful input format. The system determines the current position (the beginning location) based on automated positioning (assuming the display/input device is attached to the user) and/or user input. For example, the beginning location may be determined by a global positioning system (GPS), a cell phone network infrastructure (e.g., triangulation), or can be input by the user, using any of the input formats described above.

The system calculates potential routes from the beginning location to the end location and may select one of the potential routes (e.g., the best route) and output the selected route to the user. Once the system obtains the ending and beginning locations, the system may calculate potential routes from the beginning location to the end location and may select one of the potential routes (e.g., the best route). The “best” route can be selected based on predetermined criteria or criteria established by the user. Such criteria can include the best route being the shortest route, the quickest route, the least expensive route, the most scenic route, or other similar criteria. Further, the user may select the “best” route from all possible routes, or a subset of some of the “best” routes as determined by the criteria discussed above. This selected route is output to the user either in printed form or as directions on a graphic user interface (not explicitly shown) of the display/input device.

Each potential route may include one or more route portions. For example, each route portion may include one or more forms of travel, such as public transportation, driving, walking, bicycling, etc. While the user is traversing the selected route, the system may output, to the user, real time navigation instructions during each of the one or more route portions. In this manner, the user may be provided with real-time instructional information such as, for example, remaining walking distance to the nearest public transportation location (e.g., bus stop, subway platform, airport gate, etc.), location of the correct waiting area for public transportation, confirmation whether the user is standing or waiting at the correct location for public transportation (e.g., correct side of the street, correct side of the subway platform, etc.), current fare information and related available forms of payment, the estimated waiting time and/or arrival time of public transportation based on information from the transit data source, and when to exit or get off a particular vehicle of public transportation. The user may also be provided with visual clues relating to public transportation (e.g., picture of a city's public bus) and/or the final destination. Information relating to the final destination may also be provided to the user such as, for example, notification of possible admission charges relating to the final destination. Other real-time information may be provided to the user via the display/input device and the above list should not be construed as exhaustive.

In practical scenarios, pedestrians may be distracted or otherwise choose to deviate from the selected route (e.g., enter a store, restaurant, etc.). In this scenario, the display/input device may be used lo suspend and resume tracking based on user input. With this purpose in mind, the system may re-determine the user's current position based on intermittent automated positioning calculations and/or user input. Based on the re-determined current position, the system dynamically recalculates potential routes from the re-determined current position to the end location. In embodiments, the system's real-time navigation functionality determines whether one route portion has been completed based on comparing an elapsed time with an average historical time for that route portion, which is useful if device-based information is not available or user input is not forthcoming.

The potential routes include public transportation as portions of the potential routes. Therefore, the system may be used by urban foot travelers who walk through urban environments and ride along public transportation systems (as contrasted with individuals traveling within personal automobiles or traveling by foot in rural or hiking environments). Thus, for purposes herein, the “public transportation route portions” of the potential and selected routes include public and commercial bus portions, public and commercial train portions, public and commercial subway portions, public and commercial ferry portions, public and commercial taxi portions, public and commercial airline flight portions, motorized and unmotorized pedestrian walks, and all similar forms of public transportation (all of which may be independent of each other).

In addition, the system outputs, to the user, real-time navigation instructions from route portion to route portion while the user is traversing the selected route. This real-time navigation may include disclosing a number of route portions to the user, one (or a few) at a time. Thus, as the user completes one route portion, they arc then presented with the next route portion in real-time navigation. Each route portion includes a different route portion of the public transportation route portions. For purposes herein, a “different route portion” comprises a subsequent route portion which, when compared to a prior route portion, requires the user to physically move from one of the public transportation route portions to a different one of the public transportation route portions (e.g., move to a train or different train, move to a bus or different bus, etc.). Thus, each different route portion requires the user to change buses, trains, ferries, planes, etc, (e.g., change from a bus route to a train route or vice-versa, walk between different types of mass transit rides, etc.).

During the real-time navigation, the method dynamically recalculates the selected route based on the then-current position. Therefore, if the user takes the wrong bus, wrong subway line, etc., the system can get the user back to the end location. It should be understood that the current position of the user may be determined utilizing existing cell phone network infrastructures (e.g., via triangulation). In this manner, the current position of the user may be determined in tunnels and underground subway systems where cell phone network infrastructures are present. However, scenarios exist in urban environments where GPS calculations are inhibited by subway tunnels and/or large buildings blocking a clear view of the sky required for GPS calculations. In these scenarios, the system re-determines the current position based on intermittent automated positioning calculation (based on intermittently received GPS signals, when available) and/or user input. Thus, the user can manually enter when each route portion has been completed, so the next route portion may be displayed. Alternatively, the portion-by-portion navigation may determine whether one route portion has been completed based on comparing an elapsed time with an average historical time for that route portion. Such “elapsed time” based position calculations are usually quite reliable because the route traveled by the various public mass transit is fixed, and is usually completed is a very consistent average time. Further, the elapsed time based position calculations may be confirmed or corrected as the intermittent GPS signals (or user input) arc received. These features are especially useful if satellite-based information is not available or user input is not forthcoming.

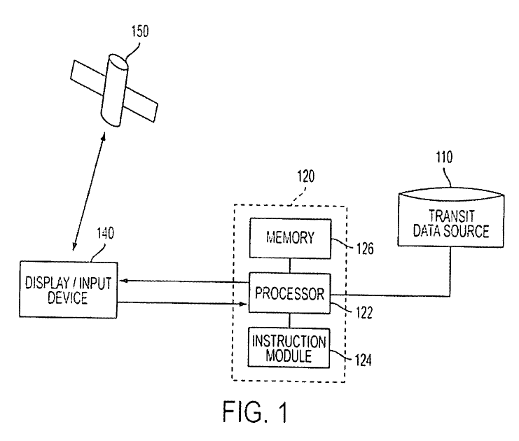

An embodiment of the present disclosure is shown in FIG. 1 and includes a transit data source 110 that contains the street maps of a given city and the routes of the mass transit systems. The schedules of the mass transit systems are available, and other items, such as a directory of points of interest may optionally be provided. This information is uploaded to a central processor 122 of a pedestrian navigation server 120 and stored in an associated storage device or memory 126. The pedestrian navigation server 120 may be any suitable network device running any known operating system and configured to communicate data over a network. In other words, a computer, switch, router, gateway, network bridge, proxy device or other network device that is programmed or otherwise configured to operate as explained herein is considered an embodiment of this disclosure. The memory 126 is adapted to store various data such as mass transit maps, pedestrian maps, mapping software applications, bus routes, train schedules, airline schedules, and any other suitable information from the transit data source 110. An instruction module 124 is used by the processor 122 to develop and select potential routes for communication to a display/input device 140. The device 140 is adapted to wirelessly communicate with a navigational satellite 150 (e.g., GPS satellite) to provide output to the user. The device 140 may include a suitable processor operatively connected (directly or indirectly) to a power supply (e.g., a battery), a memory, a graphic user interface, and an antenna. As would be understood by those ordinarily skilled in the art, the present embodiments are not limited to this specific structure. Instead, the structures discussed herein are merely examples used to illustrate features of the disclosure and should not be construed as exhaustive.

The transit data source 110 is adapted to store various items of information such as mass transit route portions. Such mass transit route portions include public and commercial bus route portions, public and commercial-train route portions, public and commercial subway route portions, public and commercial ferry route portions, public and commercial taxi/limousine route portions, motorized and unmotorized pedestrian walks, etc., all of which may be independent of each other. Further, the transit data source 110 stores the time schedules for stops along such route portions, the average elapsed time for each of the route portions (the average walking time for walking portions). Such information may be updated (e.g., via connection to the internet) with new routes and time schedules, current delays, current detours, etc.

The user communicates with the device 140 through a display/input (e.g., a graphic user interlace which can include a screen, keypad, pointing device, speaker, microphone, etc.) to input a request to the server 120 for directions. A suitable location sensor or antenna (not shown) incorporated with the device 140 may be interrogated by the satellite 150 to obtain the starting point or this may be input by the user. The system may also make points of interest from the transit data source 110 available to the user.

Once the user has decided on a destination, a request from the device 140 to the pedestrian navigation server 120 is made that may include items such as the starting point, the destination, and the date and time. The central processor 122 and associated instruction module 124 uses this information along with the information from the transit data source 110 to create detailed directions. The display/input unit 140 conveys the detailed directions to the user and tracks the user (e.g., via incorporated location sensors) as the detailed directions are followed.

More specifically, the display/input device 140 is adapted to receive, as user input, a desired destination as the end location and wireless positional information (such as GPS signals) via, e.g., an incorporated antenna. This allows the processor 122 to determine the current position as the beginning location (based on the wireless positional information received through the device 140 or user input received through the device 140). Further, the processor 122 calculates potential routes made up of mass transit route portions from the beginning location to the end location based on calculations executed by the instruction module 124. The processor 122 selects one of the potential routes as a selected route, automatically or based on user selection. The device 140 outputs the selected route to the user through a display, printout, and/or verbal instructions.

Further, the processor 122 is adapted to calculate real-time navigation while the user is traversing the selected route. The device 140 outputs the real-time navigation instructions. During the real time navigation, the processor 122 is further adapted to dynamically recalculate the selected route based on the current position. The current position can be based on intermittent receipt of wireless position information from the satellite 150 or user input received through the graphic user interface of the device 140.

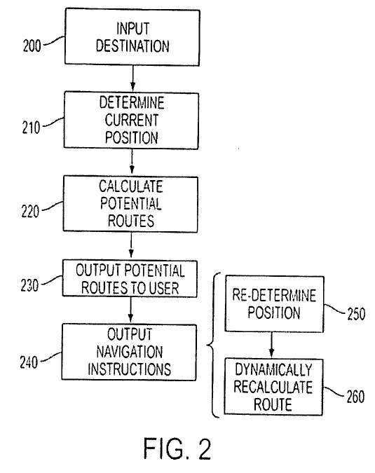

As illustrated in the flowchart shown in FIG. 2, a desired destination is received from user input as the end location 200. The system determines the current position (the beginning location) based on automated positioning and/or user input in item 210. With this information, the system calculates potential routes (item 220) from the beginning location to the end location and may select one of the potential routes (e.g., the best route) for output to the user in item 220.

In addition, the system outputs (display, printout, audible instructions, etc.), to the user, real-time navigation instructions (item 240) while the user is traversing the selected route. This real-time navigation includes route portions, wherein each route portion includes a different form of travel (e.g., walking, public transportation, bicycling, taxi, limousine, etc.).

During the real-time navigation, the system re-determines the current position (item 250) based on intermittent automated positioning calculation and/or user input. Further, the system dynamically recalculates the selected route (item 260) based on the re-determined current position. In embodiments, the system may determine whether one route portion has been completed based on comparing an elapsed time with an average historical time for that route portion, which is useful if device 140 based information is not available or user input is not forthcoming. In other words, the processor 122 can begin counting the elapsed time at the beginning of a route portion and automatically move to the next route portion when the average elapsed lime for that route portion has been reached. This gives the user the option to use the navigation device within areas that have no access to GPS or similar positional indicators, without having to constantly input their current position or having to manually move from each route portion as a previous route portion is completed.

The embodiments herein are specifically applicable to portable navigation systems and can be incorporated into, for example, web-enabled cell phones, personal digital assistants (PDAs), hand-held navigation devices, watches, MP3 players, portable computers, etc. The embodiments herein produce many advantages over existing navigation systems and mass transit hard copy maps because the embodiments herein integrate these two concepts in a single easy to use package. Thus, the embodiments herein inform the user not only where to go to catch the subway, bus, etc. but also specifies the exact subway line, bus route number, etc., the time of departure of the ride, as well as the specific slop to get off and walk or transfer to the next ride. Further, as described above, the embodiments herein can be used with limited or no GPS or other wireless positional support signals and arc, therefore, very useful for urban or underground trips.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the an which are also intended to be encompassed by the following claims.

What is claimed is:

1. A method, comprising:
receiving information, including a user-desired destination as an end location, from a user-operated computing device;
electronically determining a current location of a user as a beginning location based on positional information received from the user-operated computing device;
based on the information, electronically generating potential routes from the beginning location to the end location;
electronically selecting one of the potential routes as a selected route;
outputting, to the user-operated computing device, (1) the electronically selected route, wherein the electronically selected route includes at least one of a mass transit portion, a motor vehicle route portion, and a pedestrian walking route portion, and (2) navigation instructions based on a then-current location of the user between the beginning location and the end location.

2. The method according to claim 1, further comprising:
dynamically regenerating the selected route based on the then-current location of the user, wherein the regenerating comprises electronically re-determining the current location based on least one of intermittent automated positioning and user input.

3. A method according to claim 2, further comprising:
receiving information, including a request for a livery vehicle, from the user-operated computing device; and
dispatching the livery vehicle to the then-current location of the user.

4. A method according to claim 1, wherein the mass transit portion includes at least one of a public and commercial bus portion, a public and commercial train portion, a public and commercial subway portion, a public and commercial air travel portion, a public and commercial ferry portion, and a public and commercial taxi portion.

5. A method according to claim 1, further comprising:
receiving, as user input, an air travel itinerary from the user-operated computing device, wherein the outputting further comprises outputting, to the user-operated computing device, navigation instructions based on the received air travel itinerary.

6. A method according to claim 5, further comprising:
receiving, as user input from the user-operated computing device, identification data corresponding to luggage belonging to the user.

7. A method according to claim 1, wherein the user-operated computing device is a network-enabled cell phone.

8. A method according to claim 1, further comprising:
accessing a network server adapted lo generate navigation and tracking data lo the user-operated computing device.

9. A method according lo claim 1, wherein the outputting of the navigation instructions includes determining a completion of a route portion based on a comparison between an elapsed time and an average historical time for the route portion.

10. A method according to claim 1, wherein the outputting of the navigation instructions includes at least one of outputting, to the user-operated computing device, a waiting location, a confirmation that the then-current location of the user is the correct waiting location, an estimated arrival time of a mass transit portion vehicle, an indication to exit the mass transit portion vehicle based on the then-current location of the user, and a fare associated with travel on the mass transit portion vehicle.

11. A method according to claim 10, wherein the outputting of the navigation instructions includes outputting, to the user-operated computing device, an image identifying the mass transit portion vehicle.

12. A navigation system, comprising:
a network server adapted to receive, as user input, a desired destination as an end location from a user-operated computing device, the user-operated computing device adapted to receive wireless positional information to calculate a current location of the user-operated device as a beginning location;
a processor operably connected to an instruction module and a memory adapted to store transit data received, by the processor, from a transit data source, wherein the instruction module is configured to calculate potential routes from the beginning location to the end location based on the stored transit data and to select one of the potential routes as a selected route, wherein the user-operated computing device is adapted to receive, as output from the network server, at least one of the selected route and real-time navigation instructions based on a then-current location of the user-operated computing device; and
a livery service utility operating on the network server and adapted to receive, as user input, a request for a livery service vehicle to the then-current location of the user-operated computing device, wherein the user-operated computing device is adapted to receive, as output from a corresponding livery service, a confirmation that the livery service will dispatch a livery service vehicle to the then-current location of the user-operated computing device.

13. A system according to claim 12, wherein the potential routes include at least one of a mass transit route portion, a motor vehicle route portion, and a pedestrian walking route portion, wherein the mass transit route portion includes at least one of a public and commercial bus route portion, a public and commercial train route portion, a public and commercial subway route portion, a public and commercial ferry route portion, a public and commercial taxi route portion, and a public and commercial air travel route portion.

14. A system according to claim 13, wherein the mass transit route portion is generated based on the transit data received from the transit data source.

15. A system according to claim 12, wherein the user-operated computing device is adapted to receive the wireless positional information from a GPS satellite.

16. A method comprising:
receiving information, including at least one of a user-desired destination as an end location and an air travel itinerary, from a user-operated computing device;
electronically determining a current location of a user as a beginning location based on positional information received from the user-operated computing device;
based on the information, electronically generating potential routes from the beginning location to the end location;
electronically selecting one of the potential routes as a selected route;
outputting, to the user-operated computing device, (1) the electronically selected route, wherein the electronically selected route includes at least one of a mass transit portion, a motor vehicle route portion, and a pedestrian walking route portion, and (2) navigation instructions based on at least one of the air travel itinerary and a then-current location of the user between the beginning location and the end location; and
dynamically regenerating the selected route based on the then-current location of the user.

17. A method according to claim 16, wherein the regenerating comprises electronically re-determining the current location based on least one of intermittent automated positioning and user input.

18. A method according to claim 16, further comprising:
receiving information, including a request for a livery vehicle, from the user-operated computing device; and
dispatching the livery vehicle to the then-current location of the user.

19. A method according to claim 16, wherein the mass transit portion includes at least one of a public and commercial bus portion, a public and commercial train portion, a public and commercial subway portions, a public and commercial air travel portion, a public and commercial ferry portion, and a public and commercial taxi portion.

20. A method according to claim 16, wherein the user-desired destination is received as one of a street address, a street intersection, a latitude/longitude location, and a point of interest.
